(19) United States
(12) Patent Application Publication
(10) Pub. No.: US 2009/0025042 A1
(43) Pub. Date: Jan. 22, 2009

(54) METHOD FOR TRANSMITTING DIGITAL TELEVISION SERVICES, CORRESPONDING GATEWAY AND NETWORK

(76) Inventors: Willem Lubbers, Cesson Sevigne (FR); Ingrid Autier, Domloup (FR); Thierry Tapie, Rennes (FR)

Correspondence Address: Joseph J. Laks;Thomson Licensing LLC, 2 Independence Way, Patent Operations, PO Box 5312, PRINCETON, NJ, 08543, US

(21) Appl. No.: 12/086,733

(22) PCT Filed: Dec. 6, 2006
(86) PCT No.: PCT/EP2006/069366

§ 371 Date: Jun. 18, 2008

(30) Foreign Application Priority Data
Dec. 20, 2005 (FR) 0553970

(51) Int. Cl. H04N 7/20

(52) U.S. Cl. 725/70

(57) ABSTRACT

The invention concerns a method for-transmitting digital television services via a gateway suitable to receive several digital multiplexes, each multiplex comprising at least one digital audiovisual service, the gateway being capable of receiving a limited number of multiplexes among the said plurality and of transmitting them to at least one terminal. In order to improve access to the service when the gateway reaches its capacity limit, the gateway transmits a list of at least one available service, to at least one of the terminals; the available services being present on the multiplexes, that the gateway can receive depending on the possible services already transmitted to at least one of the said terminals.

### 1. SCOPE OF THE INVENTION

This invention relates to the field of digital television and more specifically its broadcast of services at home.

### 2. TECHNOLOGICAL BACKGROUND

Depending on the prior art, solutions should be proposed which enable the reception of services by terminals connected to a gateway (or DNG from the English “Delivery Network Gateway”) via a network of IP type for example (from “Internet Protocol” defined by the referenced standard RFC791). Digital service operators each have a service offer. These services are regrouped within service sets. Each set, named multiplex, is composed of one or more streams of digital data. These multiplexes are distributed via a broadcasting link which may correspond to a given frequency sent by a satellite or a network cable head or TNT transmitter (or terrestrial digital television or DVB standing for “Digital Video Broadcasting”). Each multiplex will be able to contain one or more services.

A DNG is equipped with a reception tuner, the tuner enabling connection to the satellite, or the cable, or even the TNT by using the given frequency, and reception of the multiplex of digital data which is broadcast there. A service within this multiplex is defined as a sequence of emissions broadcast within the framework of a programming defined by a broadcaster. When a first terminal connected to the DNG requests a service, the tuner of the DNG locks onto the frequency of the multiplex comprising the required service. The accesses to the services of the different multiplexes possible via the other terminals are then disturbed, the tuner not being able to offer all the services associated with all the multiplexes which may be received, notably for the services which are located within other multiplexes and thus on other frequencies.

This technique thus presents the disadvantage of not being optimised for a domestic network which comprises several terminals linked to a gateway enabling the reception of a limited number of multiplexes.

### 3. SUMMARY OF THE INVENTION

The purpose of the invention is to overcome the disadvantages of the prior art.

More particularly, the purpose of the invention is to facilitate terminal access to a service relayed by a gateway, when at least one possible other terminal is already receiving a service relayed by a gateway which thus reaches its reception capacity limits for multiplexes containing digital television services.

For this purpose, the invention proposes a method for transmitting digital television services via a gateway able to receive a plurality of digital multiplexes; each multiplex comprising at least one digital audiovisual service, the gateway being adapted to receive a limited number of multiplexes among the plurality (the said number notably being limited according to the capacity of one or more reception tuners), and to transmit them to at least one terminal connected to the gateway; the method being remarkable in that it comprises a transmission step of a list of at least one service, called available services, to at least one of the terminals; the available services being present on the multiplexes that the gateway may receive, the list of available services depending on the possible services already transmitted to at least one of the terminals.

Hence, the management of access to the services is facilitated since when the gateway is limited in reception capacity, the terminals receive a list of available services and thus do not require services which they do not have access to at a time where the resources of the gateway are assigned to the transmission of services requested by other terminals.

Preferentially, the method comprises a reception step of at least one multiplex, the list of available services comprising the services present in the multiplex(es) received when the multiplex reception capacity of the gateway has been reached and does not comprise the services of the other multiplexes.

According to an advantageous characteristic, each terminal having an access priority to the services transmitted by the gateway, the method comprises a determination of a maximum terminal priority according to the priority of the terminals accessing a service, a list of services comprising the services present in the multiplex(es) received when the multiplex reception capacity of the gateway is reached and is transmitted to the priority terminals which are less than or equal to the maximum priority.

According to a particular characteristic, a list of services comprising all the services of the multiplex plurality is transmitted to the terminals with a priority strictly greater than the maximum priority.

Advantageously, the table is transmitted to all the terminals which do not receive a service.

According to particular characteristics, the multiplexes are transmitted via satellite and/or are of the terrestrial digital television multiplex type.

According to a preferred characteristic, the transmission step of a list of at least one service, called available services, to at least one of the terminals is a broadcast according to a UDP protocol.

According to another characteristic, the method comprises at least one step of management of sending of a service to a terminal comprising a transmission of a command according to an IGMP protocol. The service sending management step comprises for example one or more IGMP commands among the “join”, “leave” and “keep alive” commands.

The invention also relates to a gateway suitable for receiving a plurality of digital multiplexes and to transmit digital television services; each multiplex comprising at least one digital audiovisual service, the gateway being suitable to receive a limited number of multiplexes among the plurality and to transmit them to at least one terminal connected to the gateway. According to the invention, the gateway comprises means for transmitting a list of at least one service, called available services, to at least one of the terminals; the available services being present on the multiplexes that the gateway may receive, the list of available services depending on the possible services already transmitted to at least one of the terminals.

In addition, the invention concerns a communication network comprising terminals and a gateway as illustrated above.

### 4. LIST OF FIGURES

The invention will be better understood, and other specific features and advantages will emerge from reading the following description, the description making reference to the annexed drawings wherein:

FIG. 1 illustrates a television service reception system according to a particular embodiment of the invention;

FIG. 2 is a diagrammatical block diagram of a gateway implemented in the system of FIG. 1;

FIGS. 3, 4 and 7 represent algorithms implemented by the gateway of FIG. 2;

FIG. 5 illustrates a table implemented by the gateway of FIG. 2;

FIG. 6 presents an algorithm implemented by a gateway according to an embodiment variation of the invention;

FIG. 8 illustrates an algorithm implemented by a terminal of the system of FIG. 1; and

FIG. 9 presents an example of exchanges between the different elements of the system of FIG. 1.

### 5. DETAILED DESCRIPTION OF THE INVENTION

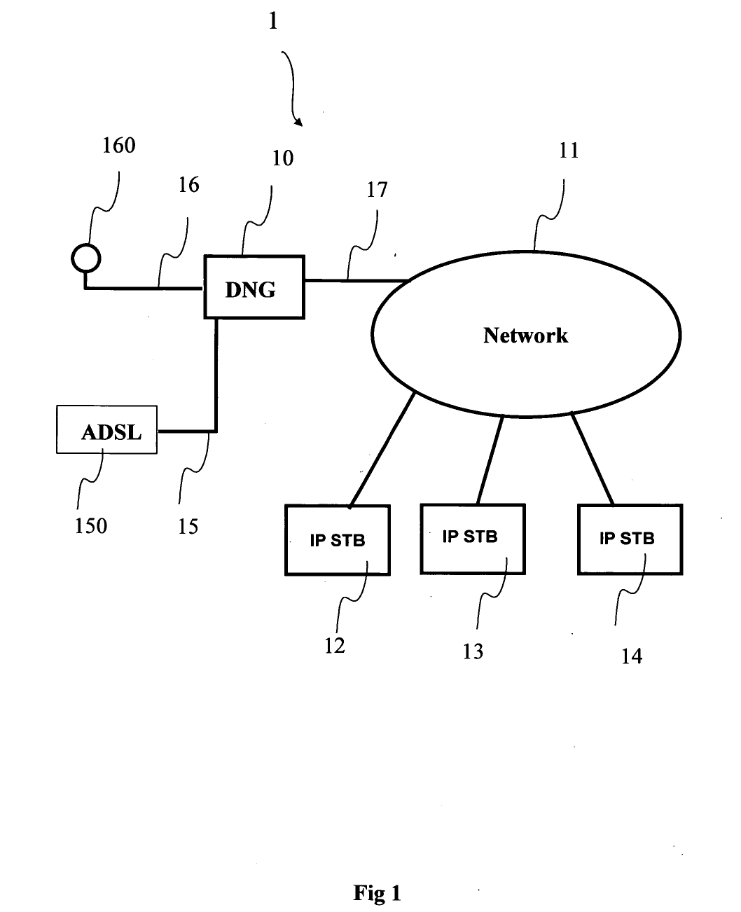

FIG. 1 illustrates a television service reception system 1 according to a particular embodiment of the invention.

System 1 comprises:
a gateway 10;
a reception antenna 160 connected to gateway 10 via a 16 link;
An interface to access an xDSL network (DSL meaning Digital Subscriber Line) 150 connected to gateway 10 via a 15 link;
a domestic network 11 connected to gateway 10 via a 17 link; and
Terminals (for example of “set top box” type or digital service receivers associated with a television and/or a recording device) 12 to 14 linked to network 11.

Network 11 is preferentially of the IP type and enables data exchange of digital television services between gateway 10 and terminals 12 to 14.

Reception antenna 160 (satellite and/or terrestrial) comprises reception means of digital television and/or radio service multiplexes (compatible, for example, with the DVB standard (from “Digital Video Broadcast”). It is suitable for the reception of signals corresponding to digital television service multiplexes and to transmit them towards gateway 10. Each multiplex is associated to a frequency. The multiplex is received via a satellite transmission (case for example of a reception compatible with the DVB-S standard) and/or via a terrestrial transmission (case for example of a reception compatible with the DVB-T standard).

Access to an ADSL network (and more generally to an xDSL network or any other digital or analogue audio/video source) is optional according to the invention. When a connection to another source than a satellite or terrestrial source is implemented, gateway 10 may integrate the service offered by this source to the list of services available by a reception via the antenna and the tuner(s) (and the corresponding multiplex(es)) connected to this antenna.

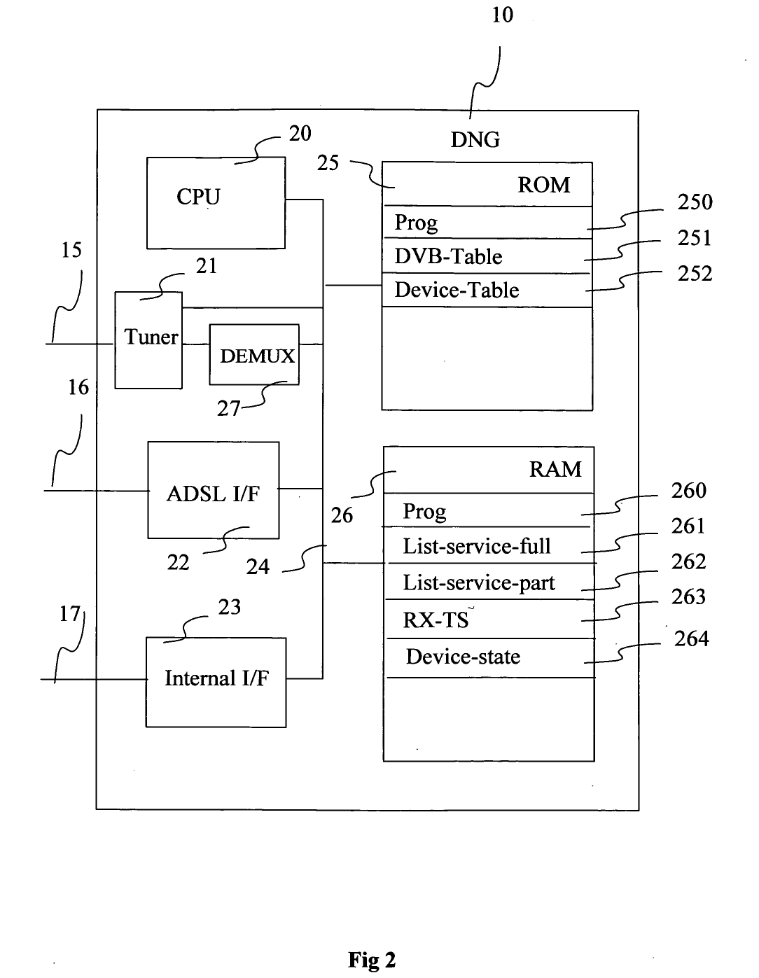

FIG. 2 diagrammatically illustrates gateway 10.

Gateway 10 comprises, interconnected by an address and data bus 24:
a microprocessor 20 (or CPU);
a non-volatile memory of the ROM type (Read Only Memory) 25;
a Random Access Memory or RAM 26;
a 21 reception tuner of the received signal on link 15;
a 27 demultiplexer receiving multiplex data transmitted by tuner 21;
a 22 xDSL interface receiving xDSL signals via link 16; and
a 23 interface linked to domestic network 11 via link 17.

Tuner 21 receives several digital television service multiplexes and may only receive one multiplex at a time. Nonetheless, it is adapted to supply simultaneously or sequentially the data from several multiplex services received.

Interface 23 receives and transmits packets (of IP type) of information data coming from or destined to the domestic network and, in particular, terminals 12 to 14.

Moreover, each of the elements illustrated in FIG. 2 is well known by the person skilled in the art. These common elements are not described here.

It is noted that the word “register” used in the description designates in each of the memories mentioned, both a memory zone of low capacity (some binary data) and a memory zone of large capacity (enabling a whole programme to be stored or all of the data representative of an image).

The ROM 25 memory comprises in particular:
a “prog” 255 program, and
a DVB-Table 251 table of services that can be selected, and
a Device-Table 252 table comprising the list of all the terminals connected to gateway 10 via network 11 and which are recorded in gateway 10, each terminal being associated to a multicast IP address on which it must remain in listening mode.

The table DVB-Table 251 comprises notably the list of services considered as interesting by the user among all the multiplex received by antenna 160. Indeed, in a configuration phase of the gateway, the user has the possibility of eliminating certain services obtained by scanning, by antenna 160, all the frequencies which the multiplexes find themselves on. For certain multiplexes, table 251 may also contain services already pre-programmed (for example services offered by subscription). In short, table 251 comprises the list of services that can be selected. For each service that can be selected, table 251 also comprises a multicast IP address which will be used, if necessary, for a broadcast of the corresponding service on network 11.

The algorithms implementing the steps of the method described hereafter are stored in the ROM 25 memory associated with gateway 10 implementing these steps. When powered up, the microprocessor 20 loads and runs the instructions of these algorithms.

Random access memory 26 notably comprises:
in a register 260, the operating programme of microprocessor 20 responsible for switching of gateway 10;
a list 261, List-Service-Full, of services that can be selected which may be received by antenna 160;
a list 262, List-Service-Part, of available services for the terminals of list 252 at a given time;
the parameters identifying the current multiplex RX-TS 263 (the current multiplex is received at the time considered by tuner 21 of the gateway); and
a table 264, Device-State, indicating for each recorded terminal its reception state.

Table 264 indicates notably whether each terminal of table 252 receives a service, and if so, an identifier of the received service, or if, on the contrary, it receives nothing.

According to a variant of the invention, the gateway comprises several tuners. It is thus able to receive several multiplexes simultaneously. In this case, list 265 of available services is limited when all the multiplexes are used by the terminals and then contains the services present in all the multiplexes received simultaneously. The register RX-TS 263 then identifies the current multiplexes, i.e. the multiplexes received at the time considered by at least one tuner of the gateway.

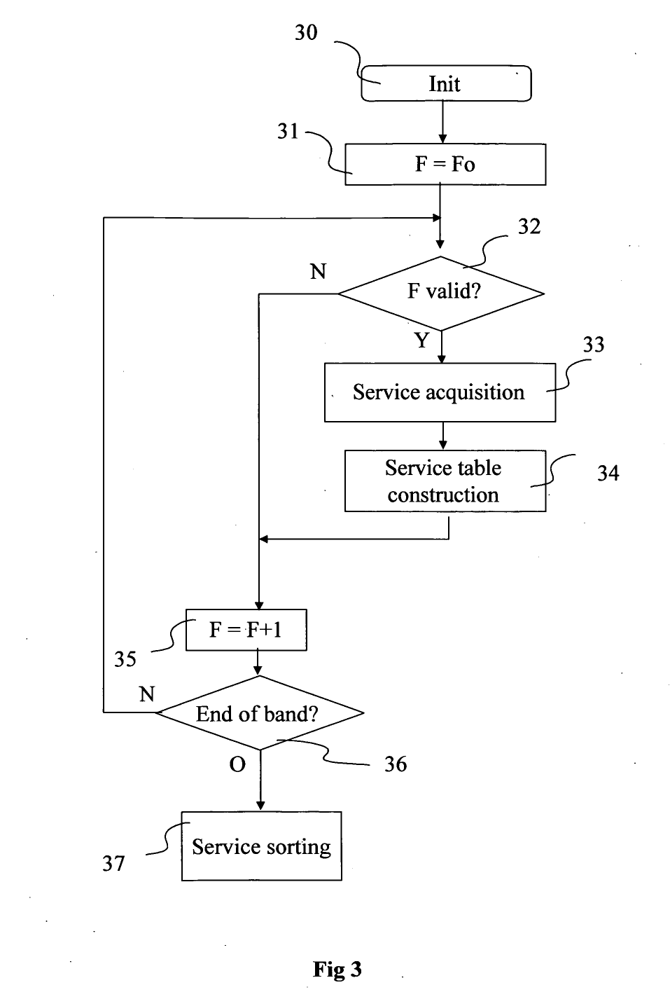

FIG. 3 illustrates in the form of a flow diagram, a service scan implemented by gateway 10. This algorithm notably enables the construction or the updating of table 250 of services that can be selected.

After a step 30 of gateway 10 initialisation, during a step 31, the gateway commands tuner 21 for it to lock on to a first frequency Fo corresponding to the low frequency of the frequency band corresponding to multiplexes capable of being received.

Then during a test 32, the gateway 10 verifies whether the current frequency is valid.

If this is the case, during a step 33, the gateway 10 receives the information relating to the multiplex corresponding to the current frequency and records a list of the services corresponding to the number of services offered by the multiplex.

Then, during a step 34, the gateway assigns a multicast IP address to each of the services present in the multiplex corresponding to the current frequency and records in a service table, the IP address with the corresponding port number.

Then, during a step 35, gateway 10 increments the current frequency.

Then, during a test 36, it verifies whether the end of the frequency band corresponding to the multiplex capable of being received is reached.

If this is not the case, test 32 is repeated.

If this is the case, during a step 37, the services are sorted, the services excl. subscription and/or those which do not interest the user being eliminated, the other services can be selected and are recorded in table 251.

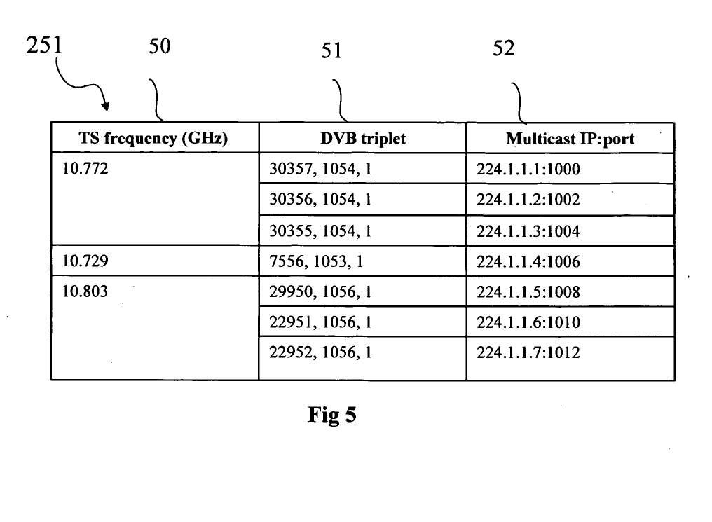

As an illustration, an example of table 251 is presented in FIG. 5. This table 251 comprises:
In column 50, the frequency of the multiplex (or TS) expressed in GHz which enables to control the tuner;
in column 51, the DVB triplet specifying the parameters specific to a service which can be selected in a given multiplex (notably the parameters which enable demultiplexer 27 to demultiplex the corresponding service from its multiplex, namely a network identifier, a transport identifier and a service identifier in a multiplex (or TS corresponding to a Transport Stream according to the DVB standards); and
in column 52, a multicast IP address and the corresponding gateway port.

Hence, for the multiplexes with the respective frequencies 10.772 GHz and 10.803 GHz, three digital television services can be selected and an IP address has been assigned to each of them. Likewise, for the multiplex with the frequency 10.729 GHz, one single service can be selected.

In the case of a satellite reception, the same frequency may contain two multiplexes, with respectively horizontal and vertical polarisation. According to this variant, table 251 also comprises the polarisation, the tuner having to know both the frequency and the polarisation in order to receive the corresponding multiplex. In addition, according to this variant, steps 31 to 36 of the service scan algorithm illustrated in FIG. 3 are executed for each of the possible polarisations and the gateway records both the polarisation and the frequency associated to a multiplex.

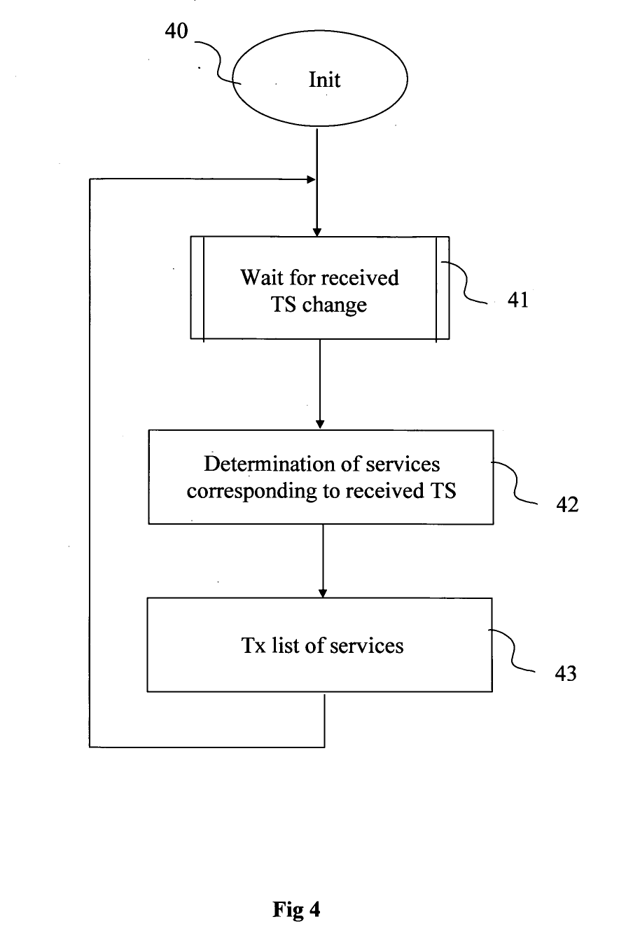

FIG. 4 illustrates in the form of a flow chart, a service transmission algorithm implemented by gateway 10. This algorithm notably manages the updating of the service list supplied to the terminals recorded by gateway 10.

During a first step 40, the gateway initialises the different variables and parameters used and notably creates the table 251 of services that can be selected by implementing the algorithm presented in FIG. 3 and records terminals 12 to 14 connected to network 11 (for example, by programming, and/or the gateway searching the terminals and/or each terminal which declares itself by the gateway) in table 252. During this step, the gateway also constructs list 261 of all the services available in a format that can be read by the terminals linked to table 251 and comprising significant information for the terminals, notably for each service:
its name;
the service provider (optional);
its IP broadcast address with the port; and
its audio and/or video format.
and possibly other information which may be useful for the terminals.
   Gateway 10 initialises table 264 with “non connected” statuses associated with each terminal. Then, transmitted gateway 10 transmits list 261 to each of the recorded terminals. This operation may notably be carried out according to one of the following manners:
the gateway transmits, to each terminal, a message on the corresponding IP address on which the terminal stays in listening mode and which comprises list 261 according to the UDP protocol (transmission mode called multicast); or
each terminal transmits to gateway 10 a get type order according to an HTTP protocol (or “Hyper Text Transfer Protocol” defined by the RFC 2616 standard) and the gateway responds with a put type command with list 261 according to the same protocol; each terminal having its own IP address to obtain the information emitted by the gateway (transmission mode called unicast).

Within the framework of the invention, the broadcasting of messages according to a multicast transmission mode is preferentially carried out according to a UDP protocol (or “User Datagram Protocol” which is defined in the RFC 768 standard) or UDP/RTP protocol (or Realtime Transmission Protocol defined in the rfc 1889 standard). The use of RTP enables a timestamp to be added to packets, and thus to recover, in reception, the time of sending when the jitter is not controlled (transmission time variation). The use of RTP also enables the insertion of sequence numbers and thus the tidying up of packets which may have been received in the wrong order.

Then, during a step 41, gateway 10 waits for a change in the multiplex received and/or service requested. This change notably corresponds to the handover of one multiplex onto another, at the start of a multiplex reception or at the stopping of a multiplex reception. Such a step is, in particular, the consequence of a service query on a multiplex, the changing of required services (also leading to a change of multiplex) and/or the stopping of a service transmission towards a terminal.

Then, during a step 42, the gateway determines the multiplexes which may be received by tuner 21. According to the embodiment mode described, one single multiplex may be received by tuner 21. In this case, if no service is transmitted to a terminal, the list of services which may be received corresponds to all the services available on the multiplexes (or streams) received by antenna 160 (provided the subscription is valid). Otherwise, gateway 21 transmits at least one service of the same multiplex received by tuner 21 to one or more terminals 12 to 14. The list of available services is then the list of services present on the received multiplex. This list is then recorded in the register 262.

Then, during a step 43, the gateway 10 transmits the list of services available 262 to each of the terminals 12 to 14 recorded with gateway 10 which are in a “non connected to a service” status. If only one terminal receives a multiplex service demultiplexed by demultiplexer 27, corresponding to the parameters identifying the multiplex recorded in register 263, it may receive any service that can be selected (indeed, to change services, it must stop the reception of the current service); gateway 10 may thus transmit to it list 261 of all the services that can be selected. On the other hand, if two terminals receive a service from the same multiplex, they prevent the gateway from switching to another multiplex. In this case, gateway 10 transmits to them the list 262 reduced to the services of the current multiplex that can be selected.

According to an embodiment variant, during step 43, gateway 10 sends to the terminals receiving list 262, a piece of information to be displayed, of “reduced service list” type (via for example a message following an http protocol if the considered terminal is equipped with a browser) with or without detailed description of the available services. This information may also comprise an identifier of the terminal or terminals receiving a service and thus responsible for the limitation of access to the services.

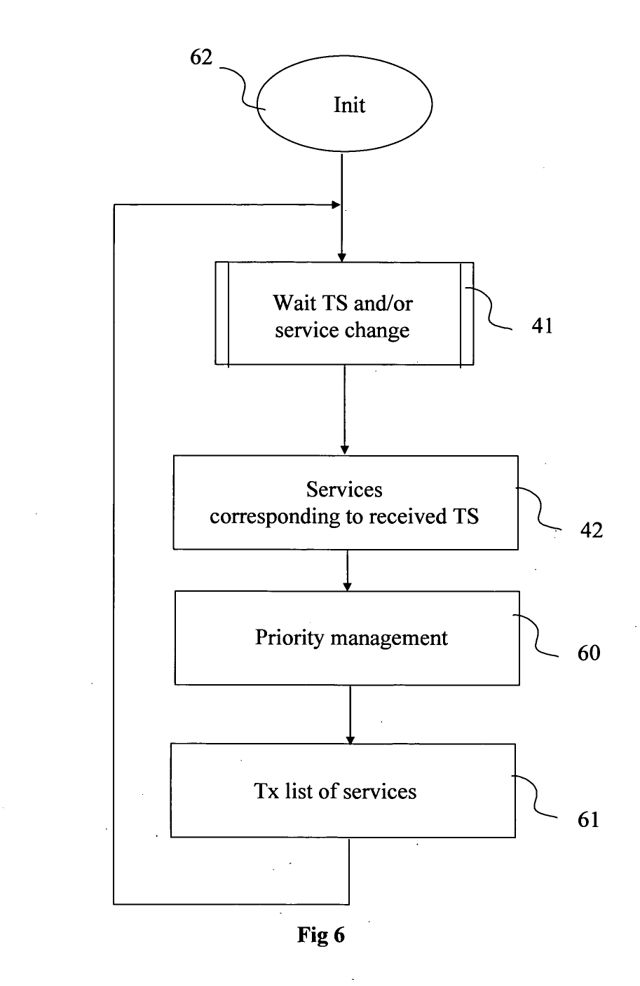

FIG. 6 illustrates in the form of a flow diagram, a transmission algorithm of services implemented by gateway 10 according to an embodiment variant of the invention, the terminals having access priority to the services. According to this variant, each terminal is assigned access priority to the audio/video services, a terminal with a higher priority than other terminals taking control of all the services even if another terminal with a lower priority is already accessing a service from another multiplex. In this case, the list of available services depends on access to a multiplex by the terminal with the highest priority level.

During a first step 62, the gateway carries out an initialisation similar to step 40 described previously by taking into account the priority level of the terminals recorded with the gateway. The priority is notably recorded in table 252. This priority may notably be defined by the user (for example, in the form of a man-machine dialogue with the gateway directly (the gateway then featuring a screen and a way of entering data (keyboard, mouse, tactile screen etc.)) or via a suitable terminal) or by configuration of the terminals (for example according to the type or a parameter specific to each machine pre-recorded or introduced by a user), the priority can be transmitted from a terminal to the gateway via an http message. According to different variants for priority management, priorities may be fixed or variable. Priorities may also be defined according to the connections, to a menu on the gateway and/or one or more terminals, and/or a user profile (for example, with an access code).

The following steps 41 and 42 are similar to the steps of the algorithm illustrated in FIG. 4; they thus have the same references and will not be described further.

Then, during a step 60, the gateway requests the multiplexer for the transmission of the service to the requesting terminal in the following cases:
no service is transmitted to a terminal;
the requested service is present on the current multiplex 263 (multiplex corresponding to a service requested by another terminal); or
the terminal has a strictly higher priority than a terminal receiving a service.

In the last case, the corresponding service is no longer transmitted to the terminal(s) receiving the service (except if it is also present in the multiplex corresponding to the service requested by the terminal with priority).

Advantageously, according to the invention, a terminal with a lower priority may not request a service which it does not have access to, since it has received a list of services limited to the services available for it.

According to different variants of the invention, the gateway sends or not to the terminal no longer receiving the requested service, an information message, and sends a default service present on the new current multiplex (pre-programmed service or other service) or sends nothing more. According to a variant of the invention, the gateway detecting a change of multiplex leading to a cutting off of the service for a non-priority terminal, may transmit a warning message to the terminal with priority (for example “this action will lead to service loss for the “identifier” terminal) and/or a confirmation message (the multiplex handover action then occurring only if the requested action is confirmed).

During step 61, the list 262 of available services is then the list of services present on the received multiplex. Gateway 10 transmits the list of available services 262 to each of the terminals 12 to 14 recorded with gateway 10 which have a strictly lower priority than the terminal with the highest priority accessing the service. Hence, these terminals may only access the services of the current multiplex. Gateway 10 also transmits the list 261 to each of the terminals who have a strictly higher priority than the terminal with the highest priority accessing a service. Hence, one of these terminals with higher priority may access any service that can be selected. If a service of the current multiplex is received by one single terminal with higher priority among the terminals receiving a service, it may receive any service that can be selected (indeed, to change services, it must stop the reception of the current service) and the gateway may transmit list 261 to it. However, if two terminals with equal priority and with the highest priority among the terminals receiving the service, receive a service from a same multiplex, they prevent the gateway from switching to another multiplex. In this case, gateway 10 transmits to them the list 262 reduced to the services of the current multiplex that can be selected. Advantageously, the priorities of the terminals are all different to avoid situations of access conflicts.

In order to detect the stopping of reception of a service by a terminal, the gateway sends IGMP messages (corresponding to the protocol “Internet Group Management Protocol” defined by the RFC 1112 standard) of keep-alive type towards the terminals to verify that the terminal is still connected to the requested service. If the terminal is connected, it responds with an IGMP message. The absence of response indicates that it is no longer connected. A terminal may also indicate the end of a service request via an IGMP command of the leave type. The use of the IGMP protocol facilitates the implementation of the described mechanisms, because the video is transmitted in multicast and a terminal will thus preferentially use the IGMP to request connection to a stream. Moreover, the IGMP already contains the support mechanism, which facilitates management of the stopping of a service when a terminal is switched off accidentally (power cut, malfunction etc.). The use of IGMP messages is thus preferable for the implementation of the invention and requires conceiving and/or implementing another protocol on top (like RTSP for example). Following the stopping of service reception by a terminal, the gateway updates the status of the corresponding terminal in table 263 and the list 262 and transmits to the terminals one of the lists 261 and 262 according to the same conditions as indicated in the description of step 43 (if no priority is managed) or 61 (with managed priority mechanism).

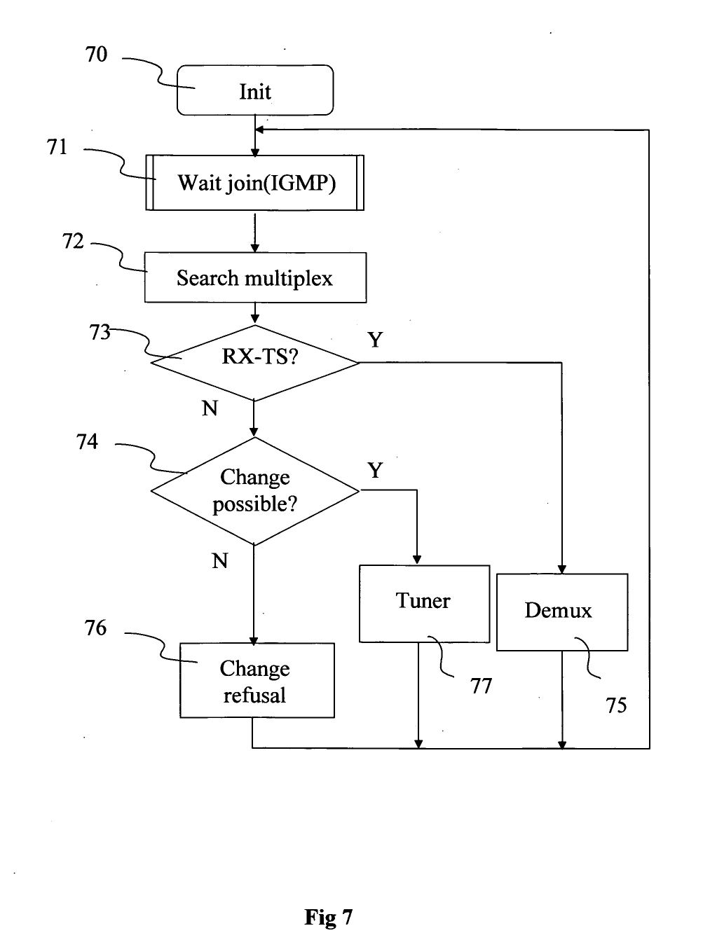

FIG. 7 illustrates in the form of a flow diagram, a processing algorithm of a service request reception implemented by gateway 10.

After an initialisation step 70, during a 71 step, gateway 10 goes into waiting mode for the reception of a join command according to the IGMP protocol emitted by a terminal on the multicast address assigned to the terminal. This command corresponds to a service request present among the services of the last list 261 or 262 received previously.

Then, during a step 72, the gateway searches for the reference of the multiplex corresponding to the service whose broadcasting address is given by the IP address present in the received join command.

Then, during a step 73, gateway 10 verifies whether this multiplex corresponds to the current multiplex.

In the affirmative case, during a step 75, the gateway requests the demultiplexer for the sending of the required service toward the requesting terminal and carries out the transmission of the service lists according to one of the steps 43 or 61 described previously. Then, step 71 is repeated.

In the negative, according to a variant implementing priority management, during a step 74, the gateway verifies whether a change of multiplex is possible as indicated in respect of the description of step 60.

If a change of multiplex if possible, during a step 77, the gateway requests the tuner for a change of multiplex and the demultiplexer for the sending of the requested service towards the requesting terminal and carries out the transmission of the service lists according to step 61 described previously. Then, step 71 is repeated.

If a change of multiplex is not possible, during a step 76, the gateway indicates to the requesting terminal that it can not supply the requested service. Then, step 71 is repeated. In theory, the invention avoids or limits passing through step 71. Nonetheless, for safety reasons, test 73 and step 76 (according to certain implementations, a list of available services may be incorrectly received or received or read late). According to a variant of the invention with no priority mechanism present, we do not implement test 73, step 75 following immediately after step 72. According to another variant of the invention with a priority mechanism, we do not implement test 74 or step 76, step 77 following immediately after a negative test 73.

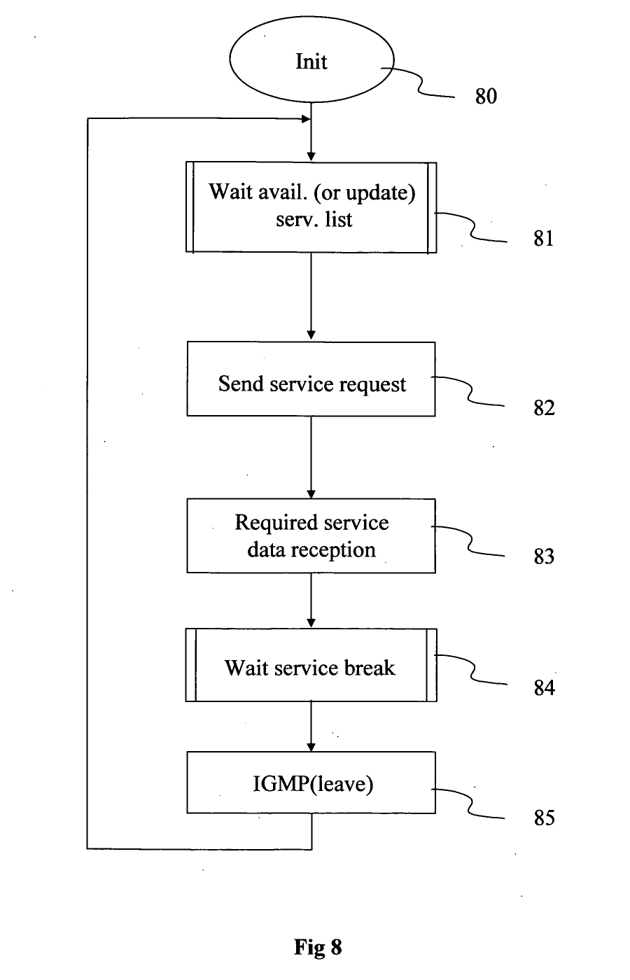

FIG. 8 presents a service reception algorithm implemented by terminal 12.

During an initialisation step 80, terminal 12 updates the parameters specific to the reception of services according to its configuration.

Then, during a step 81, terminal 12 waits then receives a list of services available and records it in its local memory. Terminal 12 may thus present it to the user.

Then, during a step 82, the terminal 12 transmits to the gateway a service request, the service being chosen among the available services belonging to the list received during step 81. The list of services depending on the possible services being transmitted to at least one other terminal, there is no conflict for accessing the multiplex containing possible services transmitted to the other terminals and the service requested by terminal 12.

Hence, during a step 83, terminal 12 receives the data corresponding to the requested service since the gateway receives the corresponding multiplex. In this manner, there is no failure associated with the non-possibility of reception of the multiplex corresponding to the requested service (the tuner is able to receive this multiplex without disturbing the other terminals). According to the variant implementing an access priority among the terminals, only the terminals with lower priority are likely to no longer receive the service which they have possibly requested.

Then, during a step 84, terminal 12 waits for the end of the service (notably corresponding to an interruption by the user or to the expiry of a time out). According to the variant implementing an access priority among the terminals, the end of the service may also correspond to the reception of a message indicating that the service is no longer available (which is the case when a terminal with more priority requests a service present on another multiplex than the multiplex comprising the service requested at step 82) or be replaced by a handover towards a default service.

Then, during a step 85, terminal 12 transmits to gateway 10 a piece of information indicating the end of the requested service such that the gateway may update the list of available services. This step 12 may be omitted if the end of the service is linked to gateway 10 (which may be the case notably during the implementation of a priority among the terminals).

After step 85, step 81 is repeated.

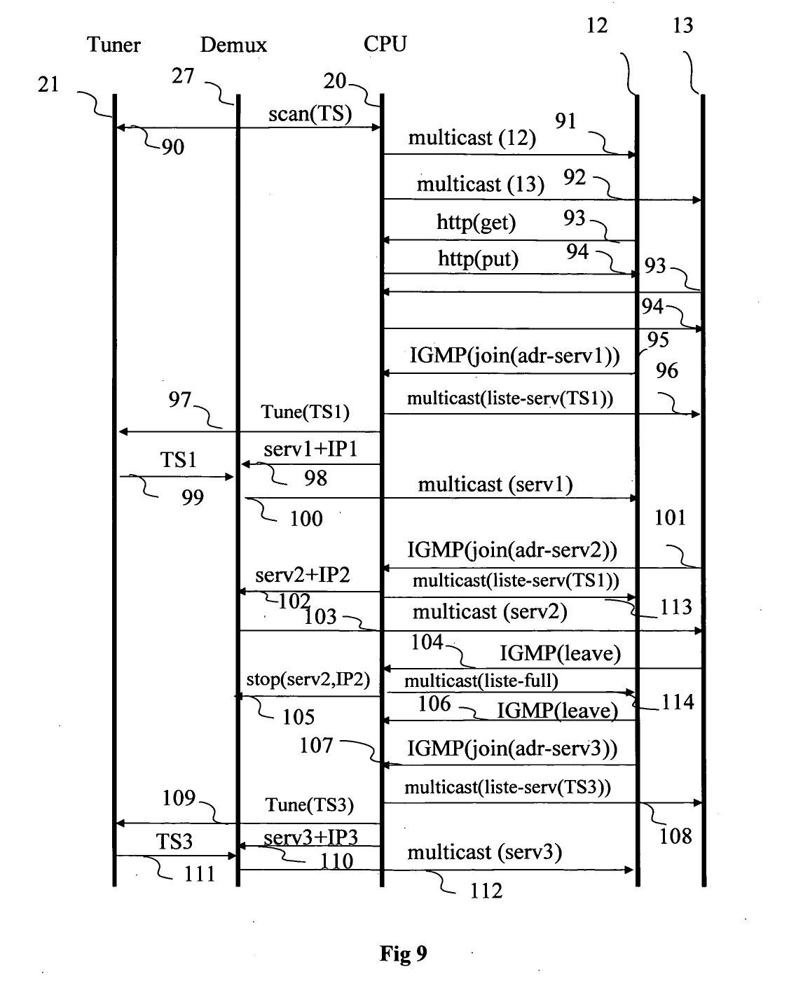

FIG. 9 presents an example of exchanges between tuner 21, demultiplexer 27, microprocessor 20 and terminals 12 and 13. In order to facilitate understanding of the implemented mechanisms, only the most important exchanges are represented. Moreover, it is assumed that the chronology of the exchanges takes place from top to bottom according to FIG. 9.

Hence, during a first step 90, the CPU 20 and the tuner 90 exchange information relating to the multiplex that can be received for the construction of table 251. Exchange 90 preferentially takes place during an initialisation phase.

Then, according to a multicast mode, the CPU 20 broadcasts towards the terminals, messages 91 and 92 comprising the list of services that can be selected, each terminal listens to a message relative to the IP address which it was assigned. Alternatively, a terminal (12 or 13 according to the illustration of FIG. 9) may transmit a command 93 get http and receive the list of services that can be selected via a command 94 put http. According to this variant, the terminals are responsible for the regular broadcast of command 93 to stay informed of any possible changes. For legibility reasons, in the following, we choose to use only broadcasting in a multicast mode.

Exchanges following any operating phase will now be described.

Hence, terminal 12 transmits to the IP address of the gateway, a join IGMP command containing the address of a requested service (which is present for example on a TS1 multiplex).

Following the reception of this request, the CPU transmits list 262 of the services present on multiplex TS1 to the other terminals (message 96 for terminal 13), request for the tuner to lock on to multiplex TS1 (message 97) and requests for demultiplexer 27 to emit the service requested on the corresponding multicast IP address (message 98) according to the data recorded in table 251.

The tuner then sends the data 99 relative to multiplex TS1 towards the demultiplexer which transmits according to a UDP protocol (or User Datagram Protocol) the service requested by message 98 on the multicast broadcasting address indicated by the CPU.

According to our example, terminal 13 transmits, to the IP address of the gateway, a join IGMP command containing the address of a requested service serv2 different from the service requested by terminal 12.

This service is available on multiplex TS1 since terminal 13 took into account message 96. The CPU then requests demultiplexer 27 for the transmission of the requested service on the corresponding multicast IP address (message 102) and transmits list 262 to terminal 12 (message 113). The demultiplexer then broadcasts the service requested by message 102 on the multicast address indicated by the CPU.

As an illustration, terminal 13 transmits a command 104 IGMP leave to CPU 20. The CPU then transmits command 105 for stopping the transmission of the serv2 service to the demultiplexer and list 261 of all the services that can be selected to terminal 12 which is now the only terminal to receive a service on the multiplex TS1 (message 113).

Then, we present a multiplex handover operation initiated by terminal 12 which first requests the CPU for a stopping of the received service (message 106 leave IGMP) then a serv3 service belonging to a multiplex TS3 (command 107 join IGMP). Commands 106 and 107 being close, it is possible that the CPU has not had time to update the reduced broadcast list and to transmit an update to the other terminals. Hence, after reception of command 107, the CPU transmits a list 262 of the services present on multiplex TS3 to the other terminals (message 108 for terminal 13), requests for the tuner to lock on to multiplex TS3 (message 109) and for demultiplexer 27 to transmit the requested service on the corresponding multicast IP address (message 110) according to the data recorded in table 251. The tuner then emits the data 111 relative to multiplex TS3 towards the demultiplexer which transmits, according to a UDP protocol, the service requested by message 112 on the multicast address indicated by the CPU.

Naturally, the invention is not limited to the embodiment mode described previously.

In particular, when the gateway is connected to an xDSL link as indicated in FIG. 1, it may propose a service available via xDSL to the terminals. In general, the xDSL bandwidth is limited and a limited number of xDSL services may be accessed simultaneously (for example a single service among several services available may be received via xDSL). In this case, when no xDSL service is received, the lists of services that can be selected comprise services available via xDSL and, possibly selected by a user or a subscription system, these services thus adding themselves to the services that can be selected (list 261) or those available at a specific time (lists 261 or 261). When a service is available both via XDSL or via the tuner, an access priority between XDSL and tuner may be defined according to any criteria and notably cots, service quality, the priority of the terminals receiving a service or requesters, the fact that a requested service belongs to a multiplex being received (if the capacity of the tuner is already used, it is more advantageous to use this capacity rather than to limit access to the services for the other terminals by using reception via XDSL). Likewise, according to a variant of the invention, handover mechanisms between XDSL and the tuner are designed according to the requested services and notably if one single service is requested on the current multiplex, whereas a terminal requests a service present on another multiplex which also comprises the service received via xDSL. When an xDSL service is received, the gateway updates the lists of available services according to this service: the reduced list of available services comprising this service and the services of the current multiplex, this list is transmitted:
to the terminals with the lowest priority or,
If no priority mechanism among the terminals is implemented, to the unconnected terminals, and to all the connected terminals if at least two terminals receive a service offered by the current multiplex.
   A list comprising the list of services that can be selected via the tuner and the service received via xDSL is transmitted to the terminals with the highest priority where, if no priority mechanism is implemented among the terminals, to one single terminal which would be connected to the current multiplex. The list of all the services that can be selected via the tuner or xDSL is transmitted to the terminal receiving a service via xDSL.

According to another variant of the invention, the gateway comprises more than one tuner, for example two, three or more (for example one or more tuners receiving a multiplex via one or more satellites and/or one or more tuners receiving a multiplex via a DVB-T system. According to this variant, as long as the reception capacity of a multiplex is not reached, the gateway transmits the list of the services that can be selected which are present on all the multiplexes. As soon as the capacity of the tuners has been reached, the gateway implements the invention as described previously, all the tuners being seen as one single tuner for the management of the lists of available services. According to a variant, when an access priority mechanism is implemented, if a priority terminal wishes to access a service which is not present on one of the current multiplexes (i.e. received at the time considered by one of the tuners), preferentially, the gateway identifies, for each current multiplex, the terminal with the highest priority receiving a service from this multiplex, identifies the terminal with the lowest priority among these terminals with the highest priority and assigns the corresponding current multiplex to the terminal with the highest priority which requests a service. Other scenarios can be considered and may be implemented according to the same principles as those mentioned above, notably:
when no priority is assigned, a terminal which does not have access to a service receives a reduced service list corresponding to the current multiplexes, and a terminal receiving a service for a multiplex which does not provide a service to other terminals preferentially receives a list of services corresponding to the list of all the selectable services;
When a priority is assigned, a terminal with a higher priority than the terminals connected receives a list of services corresponding to the list of all the services that can be selected, a terminal with a lower priority than the connected terminals receives a reduced service list when the capacities of the tuners have been reached.

Moreover, variants with xDSL links or any other wired link, and with one or more tuners may be combined according to the invention.

The invention is also compatible with any type of network associated to the gateway, this network not necessarily being domestic, but being able to be short or long distance (for example internet network).

The invention is also compatible with gateway implementations different from those of FIG. 2 and notably with gateways having a different structure and/or different interfaces or constitutive elements (more or less integrated components; etc.).

1. Method of transmitting digital television services via a gateway suitable to receive a plurality of digital multiplexes, each multiplex comprising at least one digital audiovisual service, the gateway being suitable to receive a limited number of multiplex among the said plurality, said number being limited according to the capacity of one or more reception tuners, and to transmit them to at least one terminal linked to said gateway,
wherein the method comprises a transmission step of a list of at least one service, called available services, to at least one of said terminals; the available services being present on the multiplexes that the gateway may receive, the said list of available services depending on the possible services already transmitted to at least one of the said terminals.

2. Method according to claim 1, wherein said method comprises a reception step of at least one multiplex, said list of available services comprising the services present in the multiplex(es) received when the multiplex reception capacity of the gateway has been reached and does not comprise the services of the other multiplexes.

3. Method according to claim 1, wherein each terminal having an access priority to the services transmitted by the gateway, the method comprises a determination of a maximum terminal priority according to the priority of the terminals accessing a service, a list of services comprising the services present in the multiplex(es) received when the capacity of reception of the gateway is reached and is transmitted to the priority terminals which are less than or equal to the said maximum priority.

4. Method according to claim 3, wherein a list of services comprising all the services of the said multiplex plurality is transmitted to the terminals with a priority strictly greater than the said maximum priority.

5. Method according to claim 1, wherein the said table is transmitted to all the terminals which do not receive a service.

6. Method according to claim 1 , wherein said multiplexes are transmitted by satellite.

7. Method according to claim 1, wherein said multiplexes are of the terrestrial digital television multiplex type.

8. Method according to claim 1, wherein said transmission step of a list of at least one service, called available services, to at least one of the said terminals is a broadcast according to a UDP protocol.

9. Method according to claim 1, wherein it comprises at least one step of management of a sending of a service to a terminal comprising a transmission of a command according to an IGMP protocol.

10. Gateway suitable to receive a plurality of digital multiplexes and to transmit digital television services, each multiplex comprising at least one digital audiovisual service, the gateway being suitable to receive a limited number of multiplexes among the said plurality, the said number being limited according to the capacity of one or more reception tuners, and to transmit them to at least one terminal linked to the said gateway,
wherein it comprises transmission means of a list of at least one service, called available services, to at least one of said terminals; the available services being present on the multiplexes that the gateway may receive, said list of available services depending on the possible services already transmitted to at least one of said terminals.

11. Communication network comprising terminals and a gateway, according to claim 10, suitable to receive a plurality of digital multiplexes and to transmit digital television services, each multiplex comprising at least one digital audiovisual service, the gateway being suitable to receive a limited number of multiplexes among said plurality, said number being limited according to the capacity of one or more reception tuners, and to transmit them to said terminals linked to said gateway,
the gateway comprising means for transmitting a list of at least one service, called available services, to at least one of said terminals; the available services being present on the multiplexes that the gateway may receive, said list of available services depending on the possible services already transmitted to at least one of the said terminals.
